(19) United States
(12) Patent Application Publication
(10) Pub. No.: US 2025/0262568 A1
(43) Pub. Date: Aug. 21, 2025

(54) Flow Control Devices And Methods For Stacked Tray Type Vortex Grit Removal Systems

(71) Applicant: Envirodyne Systems Inc., Camp Hill, PA (US)

(72) Inventors: Robert E. Sheker, Camp Hill, PA (US); Eric Alan Bushey, Etters, PA (US); Max H. Howie, Wellsville, PA (US)

(73) Assignee: Envirodyne Systems Inc., Camp Hill, PA (US)

(21) Appl. No.: 19/039,958

(22) Filed: Jan. 29, 2025

Related U.S. Application Data
(60) Provisional application No. 63/553,726, filed on Feb. 15, 2024.

(51) Int. Cl. B01D 21/00; B01D 21/24; B01D 21/26; C02F 1/38

(52) U.S. Cl. CPC B01D 21/0024; B01D 21/0093; B01D 21/2411; B01D 21/267; C02F 1/385

(57) ABSTRACT

An apparatus and method are proposed for controlling the number of active individual trays used in a stacked tray type vortex grit removal system as a function of flow conditions and performance requirements. In accordance with exemplary embodiments, a flow control arrangement for a stacked tray type vortex grit removal system is configured to include a bypass system which is able to selectively block one or more trays from receiving influent during low flow conditions. In one form, the bypass system may comprise one or more hinged blocking plates positioned at the entrance to selected trays, where the blocking plates may be individually activated to either allow flow to enter the associated tray, or block the movement of the flow. Other types of blocking plates (for example, sliding plates) can be used instead of hinged plates.

### CROSS-REFERENCE TO RELATED APPLICATIONS

This application claims the priority benefit of U.S. Provisional Application No. 63/553,726, filed Feb. 15, 2024 and herein incorporated by reference.

### TECHNICAL FIELD

The disclosed invention is directed to wastewater treatment systems and, more particularly, to an apparatus and method for controlling the number of active individual trays used in a stacked tray type vortex grit removal system as a function of flow conditions and performance requirements.

### BACKGROUND OF THE INVENTION

The need to remove grit from wastewater is a well-known concern. The grit takes the form of minute particles that, if not removed, interferes with the performance of downstream machinery where the grit may collect. In particular, the grit may lead to premature failure of components, accelerated wear, etc. The industry has used various arrangements over the years to remove as much grit as possible from wastewater at its initial introduction to a treatment facility. Depending on local conditions, the grit may vary in size (as well as composition), ranging from coarse grit on the order of about 500 microns down to fine grit typically on the order of about 50 microns.

Of the various types of grit removal systems, one exemplary type is a vortex-based configuration, where the influent is introduced in a tangential direction around the top periphery of a funnel-like element (referred to hereinafter as a “frusto-conical tray”, or simply “tray”). The vortex created by the circulating fluid causes the grit particulate to be directed to the sides of the tray, with the grit-free fluid spun outward and away from funnel. U.S. Pat. No. 6,881,350 issued to G. E. Wilson illustrates an exemplary vortex type of grit removal system, using a stacked set of frusto-conical trays, with the influent introduced in parallel to the vertical stack of trays, thus increasing the volume of fluid that is treated within a given space.

While considered as a workable configuration for many years, this type of vertical tray stack arrangement is fixed in form, while the volume of the influent flow may vary greatly as a function of time. As a result, during periods of low flow, the associated low vortex velocity results in the device collecting excessive organics; that is, not efficiently or effectively removing only grit debris from the influent.

### SUMMARY OF THE INVENTION

The needs remaining in the art are addressed by the present invention, which relates to wastewater treatment systems and, more particularly, to an apparatus and method for controlling the number of active individual trays used in a stacked tray type vortex grit removal system as a function of flow conditions and performance requirements.

In accordance with exemplary embodiments, a flow control arrangement for a stacked tray type vortex grit removal system is configured to include a bypass system which is able to selectively block one or more trays from receiving influent during low flow conditions. In one form, the bypass system may comprise one or more hinged blocking plates positioned at the entrance to selected trays, where the blocking plates may be individually activated to either allow flow to enter the associated tray, or block the movement of the flow. Other types of blocking plates (for example, sliding plates) can be used instead of hinged plates.

An exemplary embodiment may take the form of a stacked tray-type vortex grit removal system, comprising: a plurality of frusto-conical trays vertically stacked in columnar form, each frusto-conical tray including an inlet nozzle for directing influent thereon, an inlet chute coupled to the plurality of frusto-conical trays (the inlet chute receiving influent for processing), an inlet duct coupled to the plurality of inlet nozzles, and a bypass system configured to selectively block one or more frusto-conical trays from receiving influent during predefined operating conditions.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates a conventional, prior art grit removal system;

FIG. 2 illustrates an improved grit removal system, formed in accordance with the principles of the present invention;

FIG. 3 is an enlarged view of a portion of FIG. 2, showing in detail the inventive bypass system and in particular the position of a hinged blocking plate with respect to a tray nozzle;

FIG. 4 is a view of the same enlarged portion as shown in FIG. 3, but in this case with the hinged blocking plate disposed in its disengaged position;

FIG. 5 is a close-up view of the hinged blocking plate configuration of FIG. 4;

FIG. 6 illustrates an alternative configuration of a hinged blocking plate that may be used within a bypass system of the present invention;

FIG. 7 includes a simple block diagram of a flow control component that is used to monitor the flow rate entering inlet chute and control the position of a hinged blocking plate as a function of the monitored flow rate;

FIG. 8 illustrates an alternative bypass system formed in accordance with the present invention, which in this case utilizes a set of hinged blocking plates, each plate associated with a different tray in the stack;

FIG. 9 illustrates an alternative embodiment of the present invention, in this case using a sliding blocking plate (movable back and forth along the x-axis, for example) instead of a hinged blocking plate;

FIG. 10 is an enlarged isometric view of the sliding plate bypass system as shown in FIG. 9, particularly illustrating the movement of a sliding plate back toward a plate housing (i.e., into the disengaged position);

FIG. 11 shows an alternative configuration of FIG. 10, in this case with a sliding plate (illustrated in phantom) shifted into place within an associated housing;

FIG. 12 illustrates another example of the sliding plate embodiment, in this case configured the sliding plate to move back and forth in the z-axis direction (as shown); and

FIG. 13 shows the “outward” movement of a sliding plate in the z-axis direction away from tray's nozzle.

### DETAILED DESCRIPTION

It is proposed to modify the prior art by incorporating the ability to adjust the number of individual trays handling the influent flow, with one or more trays in the stack bypassed during low flow conditions and then bringing the bypassed trays back on line as needed. As a result, by using fewer trays during low flow conditions, a vortex velocity may be maintained that supports the removal of grit from the influent. Additionally, by using fewer trays during low flow conditions, the detention time of the organics may be reduced which supports the desirable outcome of reduced organics accumulation in the collected inorganic grit.

One embodiment may include a single bypass element that is used to remove a defined number of lower trays from service in low flow conditions. Another embodiment may configure a selected number of trays to include a bypass element to provide a finer degree of control in the number of trays involved in grit removal. The operation of the bypass system may be manual (i.e., requiring a system operator to monitor flow conditions and adjust the number of trays involved in grit removal accordingly), or automated to perform these tasks.

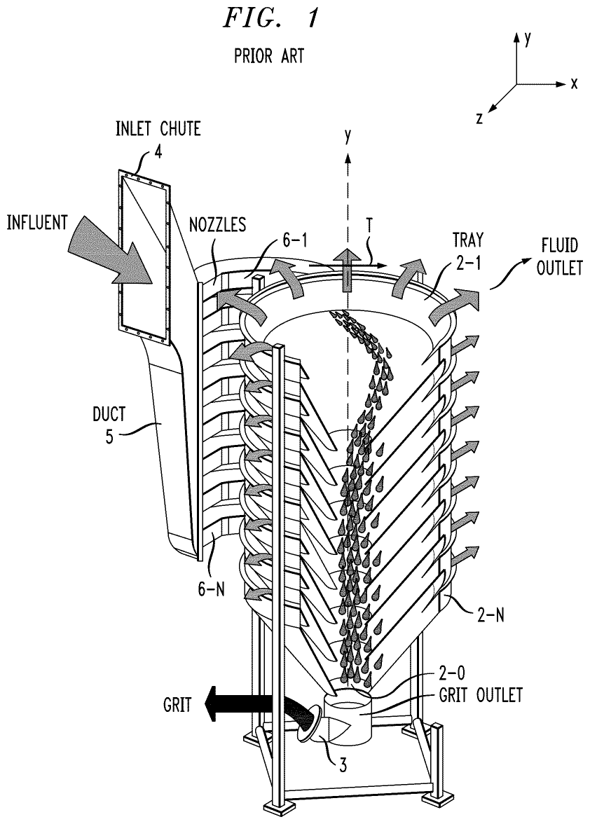

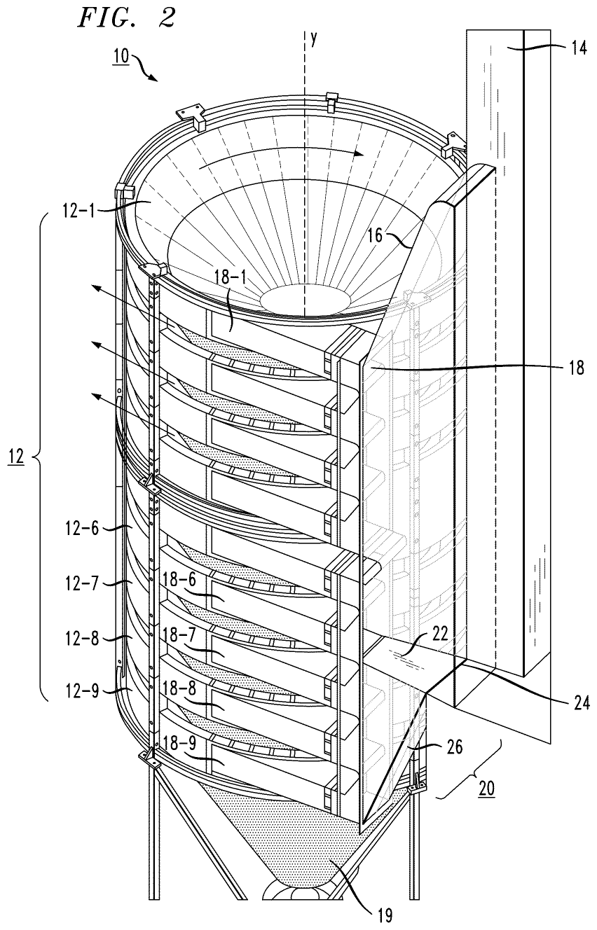

FIG. 1 illustrates a conventional, prior art grit removal system 1. A brief review of the operation of such a system is considered to be important to best understand the subject matter of the present invention, as fully described hereinafter in association with FIGS. 2-13.

Grit removal system 1 is illustrated in a partially cut-away view in FIG. 1, allowing for the geometry of the stack of trays and movement of the grit to be easily shown. System 1 is typically configured to include a plurality of frusto-conical trays 2 that are stacked in the vertical direction. The vertical direction is indicated as the y-axis in FIG. 1, and may also be considered as the direction along which the grit will move (downward) and ultimately exit system 1 through a grit outlet 3.

In operation, wastewater (hereinafter referred to as “influent”) is introduced into system 1 through an inlet chute 4, where it fills a vertically-oriented inlet duct 5. In the particular configuration shown in FIG. 1, inlet duct 5 is formed to include a plurality of separate outlet nozzles 6 disposed in a vertical direction along a sidewall of duct 5, with each nozzle associated with separate a tray in a one-to-one relationship. That is, as shown, nozzle 6-1 is coupled to tray 2-1, with this relationship continuing to the lowest tray, 2-N, where nozzle 6-N is coupled to tray 2-N.

The influent entering chute 4 continues to fill vertical inlet duct 5, which directs the influent across the plurality of trays 2 via nozzles 6. The orientation of nozzles 6 with respect to trays 2 causes the influent to enter each tray along a path essentially tangential to an upper rim of tray 2 (shown by the arrow “T” in FIG. 1). The influent will thus circulate around each tray 2, creating a vortex-type of motion, with the outlet fluid (hereinafter “effluent”) spilling out over the tops of the trays (shown by the multiple arrows in FIG. 1). The grit will then tend to move downward, passing through openings 2-O in trays 2, where it is ultimately removed via grit outlet 3.

A grit removal system 10 formed in accordance with the present invention is shown in FIG. 2. Similar to the prior art arrangement shown in FIG. 1, grit removal system 10 includes a vertical stack of a plurality of N trays 12 and an inlet chute 14 used to introduce influent to the trays. Also similar to the prior art configuration, an inlet duct 16 and a plurality of N nozzles 18 is used to introduce the influent to the individual trays. A vortex action functions to separate the grit from the fluid, with the grit directed downward and along the vertical axis Y, toward grit outlet 19. The fluid outlet (effluent) from each tray 12-i is directed tangentially away from grit removal system 10 in a manner similar to that shown in FIG. 1.

The particular configuration of FIG. 2 includes a set of nine separate trays 12 that are vertically stacked as shown, with the top-most tray designated as tray 12-1 and the bottom-most tray designated as tray 12-9. In accordance with the principles of the present invention, the number of individual trays that are used at any point in time is controlled by a bypass system 20 that functions to either fully or substantially block (referred to hereinafter as “block”, “blocking”, or “blocked”) one or more of the lower trays 12 from receiving influent via its associated nozzle 18. The specific example configuration of bypass system 20 as shown in FIG. 2 comprises an arrangement that removes a fixed number of lower trays 12 (here, trays 12-7, 12-8, and 12-9) from receiving influent flow during times of low flow rate. In particular, bypass system 20 of FIG. 2 includes a blocking plate 22 that is sized to span the gap between nozzle 18-6 and inlet duct 16, thus preventing further downward flow of influent.

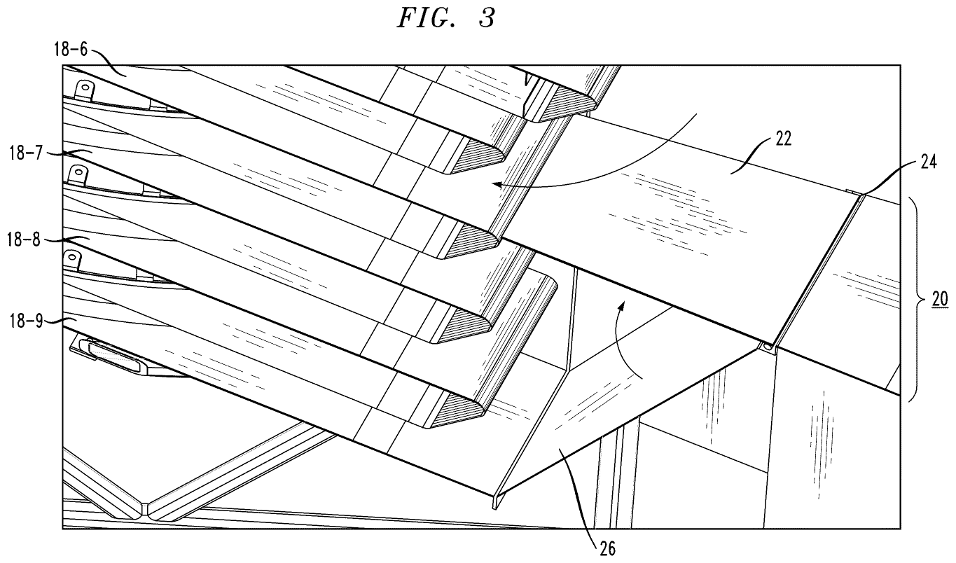

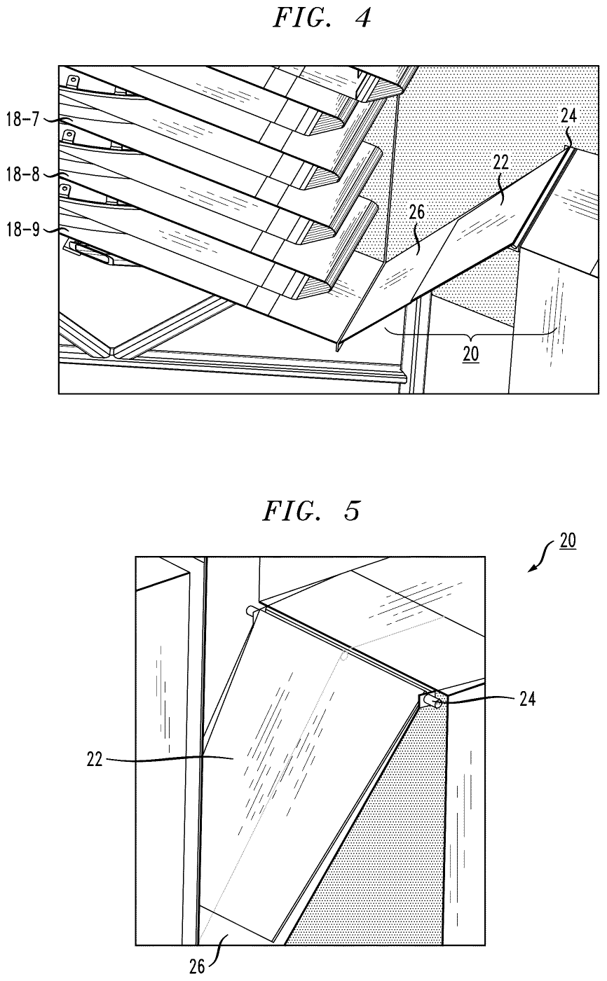

In this arrangement, blocking plate 22 is attached to inlet duct 16 via a hinge 24, which is used to move blocking plate 22 between its engaged position with nozzle 18-6 (as shown in FIGS. 2 and 3), and a disengaged position when it rests against a support surface 26 of bypass system 20 (shown below in FIGS. 4 and 5). Thus, in accordance with the practice of the present invention, during times of low flow volume, blocking plate 22 is moved into its engaged position such that only trays 12-1 through 12-6 are used in the grit removal process.

FIG. 3 is an enlarged view of a portion of FIG. 2, showing in detail bypass system 20 and the position of hinged blocking plate 22 with respect to nozzle 18-6. It is clear in this view that nozzles 18-7, 18-8, and 18-9 are blocked from receiving influent and thus their associated trays 12-7, 12-8, and 12-9 are bypassed from performing grit removal under these conditions.

In comparison, FIG. 4 is a view of the same enlarged portion as shown in FIG. 3, but in this case with hinged blocking plate 22 disposed in its disengaged position and resting against support surface 26. When blocking plate 22 is in the position as shown in FIG. 4, the lower nozzles 18 are no longer blocked and, therefore, the associated trays 12 will receive and process influent in a conventional manner. FIG. 5 is a close-up view of bypass system 20 as shown in FIG. 4, clearly illustrating the position of hinged blocking plate 22 against support surface 26.

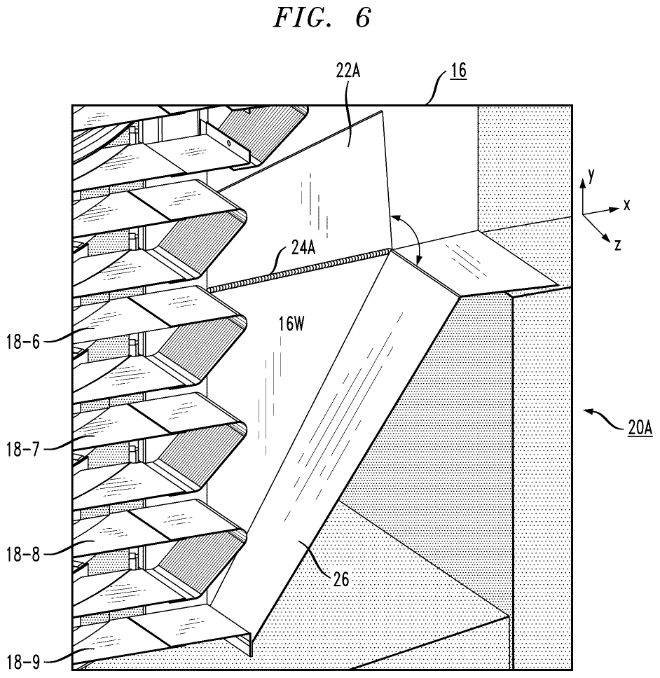

FIG. 6 illustrates an alternative configuration of a hinged blocking plate that may be used within a bypass system of the present invention. Shown here as bypass system 20A, a hinged plate 22A is shown as attached to a back wall 16W of inlet duct 16 using a hinge 24A. The view of FIG. 6 shows hinged plate 22A in an “open” (i.e., disengaged) position so that all trays are engaged in the grit removal process. Hinged plate 22A may then be lowered into position adjacent to nozzle 18-6 in order to block influent from entering lower trays.

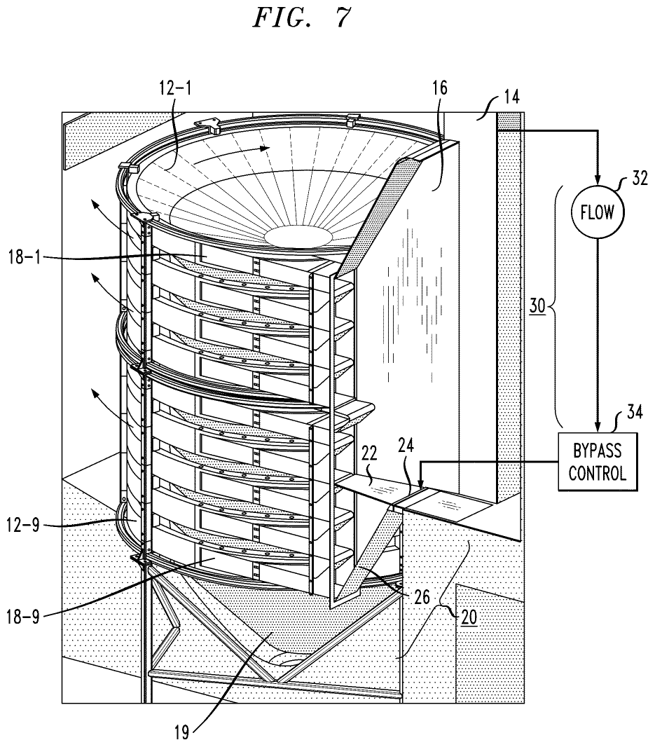

As mentioned above, the operation of bypass system 20/20A may be either manual (i.e., under direct control of personnel operating grit removal system 10) or automated. FIG. 7 includes a simple block diagram of a flow control component 30 that is used to monitor the flow rate entering inlet chute 14 and control the position of hinged blocking plate 22 (or blocking plate 22A, as the case may be) as a function of the flow rate. Flow control component 30 is shown as comprising a flow meter 32 and a tray bypass controller 34. Flow meter 32 is used to measure influent flow and transmit that information to tray bypass controller 34. Tray bypass controller 34 may store a threshold flow value and as long as the incoming influent flow rate is below the threshold, hinged blocking plate 22 (or plate 22A) is in its engaged position (as shown above) so that the lower portion of the grit removal system is bypassed. When flow meter 32 senses an increase in flow rate above the defined threshold (for example, in times of excess runoff during weather events), tray bypass controller 34 actuates hinged blocking plate 22 (or plate 22A) to move into its disengaged position.

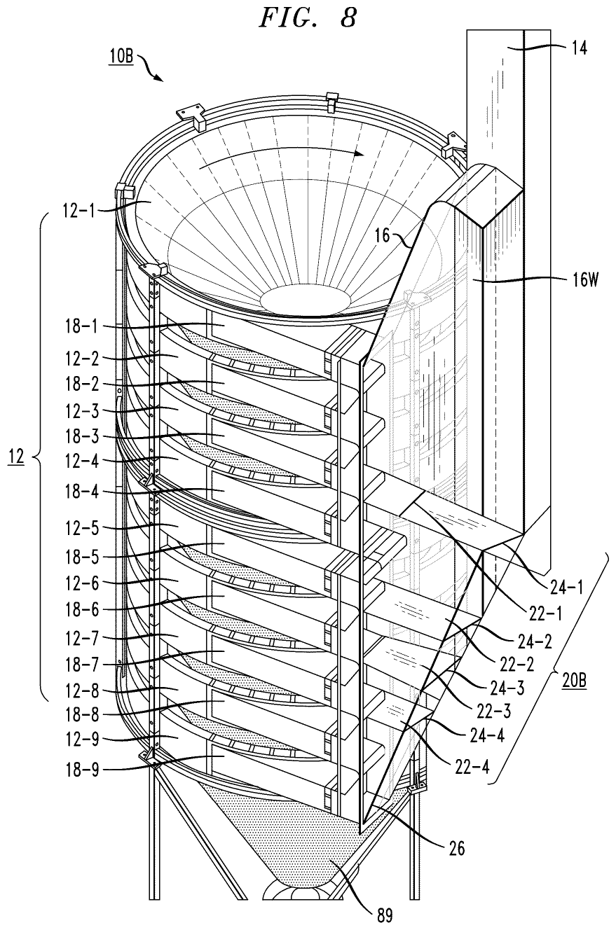

While the embodiment discussed above in association with FIGS. 2-7 depict the use of a single blocking plate that bypasses a fixed number of trays, other embodiments of the present invention may be configured to use additional blocking plates and thus providing additional control of the number of trays involved in grit removal at any point in time. FIG. 8 illustrates a grit removal system 10B including an alternative bypass system 20B also formed in accordance with the present invention, which in this case utilizes a set of hinged blocking plates 22-1 through 22-4 that are disposed for use in this case with nozzles 18-3, 18-5, 18-6, and 18-7. Hinges 24-1 through 24-4 are also shown.

In lowest flow conditions, therefore, only top three trays 12-1 through 12-3 will process the influent. As the flow increases, blocking plate 22-1 will be disengaged, allowing trays 12-4 and 12-5 to now also receive influent (with the remaining lower trays also being bypassed). Similar operation of the other blocking plates 22-2 through 22-4 is similarly based on additional changes in influent flow rate. Again, it is to be understood that the set of hinged blocking plates 22 may also be attached to back wall 16W of inlet duct 16, as discussed above in association with FIG. 6.

Additionally, it is contemplated that various other configurations may be used in the formation of a tray bypass system in accordance with the principles of the present invention (where these various other configurations may be manual, automated, or both). For example, a slide-out type of shutter plate may be disposed on the underside of a nozzle and pulled out to block off influent access to lower trays. This type of mechanism can similarly be used with multiple trays to more precisely control the number of trays involved in the grit removal process.

FIGS. 9-13 illustrate an alternative embodiment of the inventive grit removal system 80. In this embodiment, the system utilizes a tray stack 82, inlet chute 84, inlet duct 86, and nozzles 88 in the same manner as described above in association with system 10. A different type of tray bypass system is used in the embodiment, in particular a sliding plate bypass system 90. Referring to FIG. 9, bypass system 90 is shown as including a sliding plate 92 that is movable back and forth (along the x-axis, influent flow direction as shown) between an associated nozzle 88-6 and a plate housing 94 (this particular tray selection being exemplary only). Sliding plate 92 is configured in this embodiment to move between an engagement with nozzle 88-6 (which thus bypasses the lower trays 82) and disengagement (which allows for the influent to reach the lower trays).

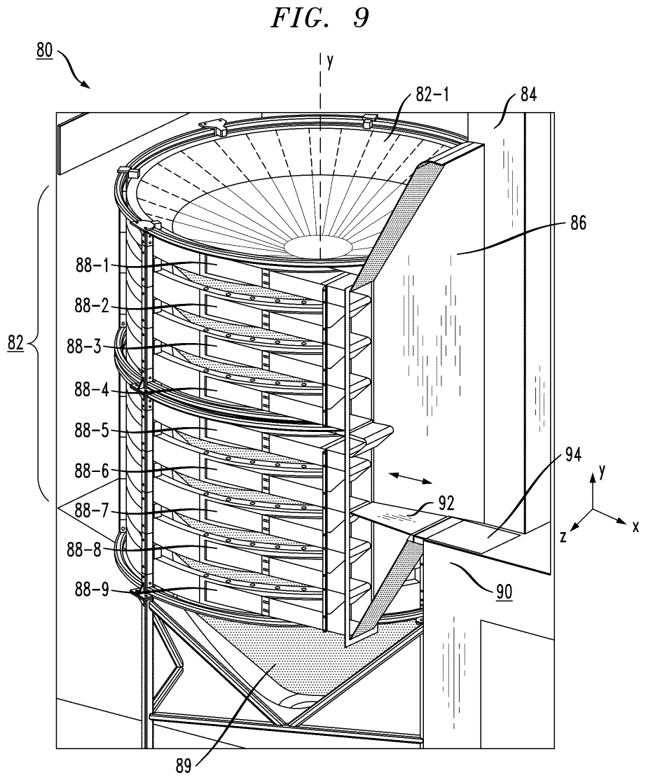

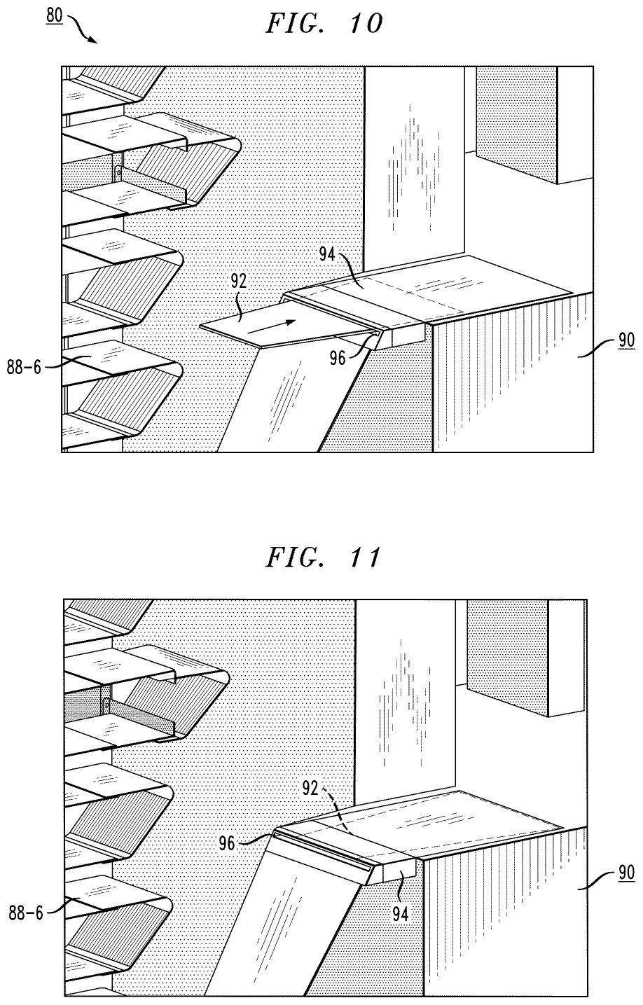

FIG. 10 is an enlarged isometric view of sliding plate bypass system 90, particularly illustrating the movement of sliding plate 92 back toward plate housing 94 (that is, into the disengaged position). In this embodiment, plate housing 94 is formed to include an access slot 96 such that plate 92 is recessed within housing 94 when not in use. FIG. 11 shows the configuration with plate 92 (illustrated in phantom) within housing 94 of sliding plate bypass system 90.

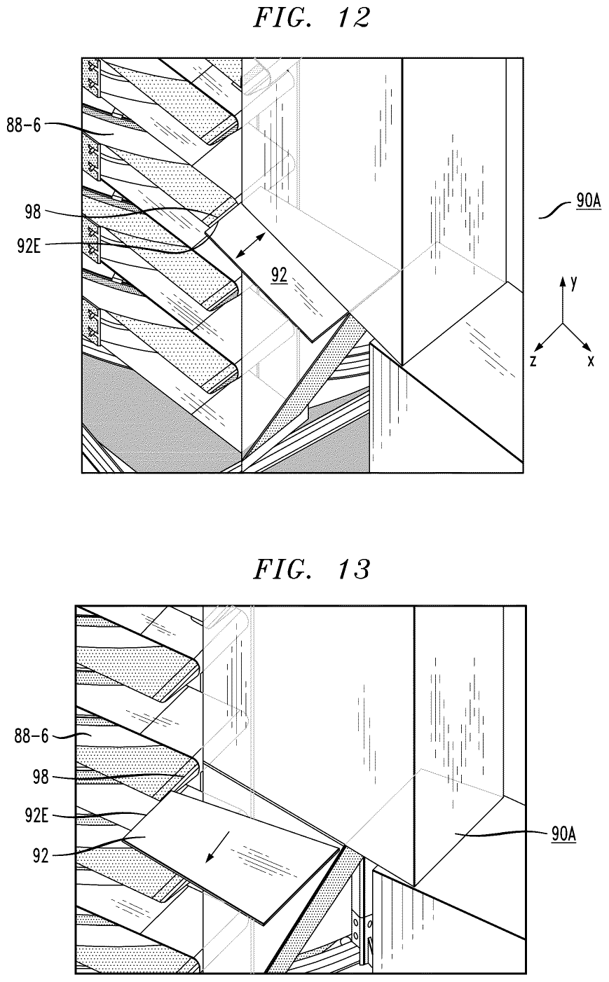

FIGS. 12 and 13 illustrate another example of the sliding plate embodiment, shown here as sliding plate bypass system 90A. In this configuration, sliding plate 92 is configured to move back and forth in the z-axis direction (as shown) between being in position between adjacent to nozzle 88-6 and removed from nozzle 88-6. FIG. 12 shows sliding plate 92 in the adjacent position, with in this example, a channel 98 is formed within nozzle 88-6 and used to support a side edge 92E of plate 92. FIG. 13 shows the “outward” movement of sliding plate 92 in the z-axis direction away from nozzle 88-6.

As with the first embodiment, the sliding plate embodiment of the inventive bypass system may be manually operated or automatically controlled in accordance with a defined operation parameters. Additionally, several trays may be configured to include a sliding bypass plate to further regulate the number of trays used in the grit removal process as a function of flow.

Moreover, while not explicitly illustrated, it is to be understood that various manual or automatic systems may be used to control the number of blocking plates involved in controlling flow through the stacked tray type vortex grit removal system.

It is to be understood that the above-described embodiments are illustrative of only a few of the many possible specific embodiments that can represent applications of the principles of the present invention. Numerous and varied other arrangements can be made by those skilled in the art without departing from the spirit and scope of the present invention as defined by the claims appended hereto.

What is claimed is:

1. A stacked tray-type vortex grit removal system, comprising:
a plurality of frusto-conical trays vertically stacked in columnar form, each frusto-conical tray including an inlet nozzle for directing influent thereon;
an inlet chute coupled to the plurality of frusto-conical trays, the inlet chute receiving influent for processing;
an inlet duct, coupled to the plurality of inlet nozzles;
a bypass system configured to selectively block one or more frusto-conical trays from receiving influent during predefined operating conditions.

2. The stacked tray-type vortex grit removal system as defined in claim 1, wherein the bypass system comprises at least one hinged blocking plate attached between a selected inlet nozzle and the inlet duct, the hinged blocking plate movable between a first, engaged position to block influent flow to all frusto-conical trays below the hinged blocking plate and a second, disengaged position permitting influent flow to pass downward and into lower frusto-conical trays forming the vertical stack.

3. The stacked tray-type vortex grit removal system as defined in claim 2, further comprising a flow control component configured to monitor influent flow entering the inlet chute and controlling positioning of the at least one hinged block plate as a function of the monitored influent flow.

4. The stacked tray-type vortex grit removal system as defined in claim 1, wherein the bypass system comprises at least one sliding blocking plate attached between a selected inlet nozzle and the inlet duct, the sliding blocking plate movable between a first, engaged position to block influent flow to all frusto-conical trans below the sliding blocking plate and a second, disengaged position permitting influent flow to pass downward and into lower frusto-conical trays forming the vertical stack.

5. The stacked tray-type vortex grit removal system as defined in claim 4 wherein the at least one sliding blocking plate is configured to move along an x-axis direction, bridging a gap between the associated inlet nozzle and the inlet duct.

6. The stacked tray-type vortex grit removal system as defined in claim 4 wherein the at least one sliding blocking plate is configured to move along a z-axis direction, into and out of a flow path between the associated inlet nozzle and the inlet duct.

7. The stacked tray-type vortex grit removal system as defined in claim 1, wherein the bypass system comprises a single blocking plate, disposed between a selected inlet nozzle and the inlet duct, the inlet nozzle selected by determining a number of trays to be bypassed by the influent during predefined operating conditions.

8. The stacked tray-type vortex grit removal system as defined in claim 1, wherein the bypass system comprises a plurality of individual blocking plates, each associated with a different one of the plurality of inlet nozzles, providing additional levels of control with respect to a number of individual frusto-conical trays utilized for grit removal at any point in time.

9. The stacked tray-type vortex grit removal system as defined in claim 8, further comprising a flow control component for determining a number of individual blocking plates of the plurality of individual blocking plates to be activated as a function of monitored influent flow conditions.
